(19) United States
(12) Patent Application Publication
(10) Pub. No.: US 2003/0005254 A1
(43) Pub. Date: Jan. 2, 2003

(54) Compatible effective addressing with a dynamically reconfigurable data space word width

(76) Inventors: Joseph W. Triece, Phoenix, AZ (US); Michael Pyska, Phoenix, AZ (US); Stephen A. Bowling, Chandler, AZ (US); Michael I. Catherwood, Pepperell, MA (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/870,462

(22) Filed: Jun. 1, 2001

(51) Int. Cl. G06F 12/00

(52) U.S. Cl. 711/200; 711/168

(57) ABSTRACT

A processor has a native word width of multiples of a byte width. The processor may, nonetheless, process, store and retrieve data in word or byte widths depending on the mode of an instruction directing the processing. Instructions may assume either a word or a byte mode. In the word mode, the instruction causes the processor to read, store and operate on word width data. In the byte mode, the instruction causes the processor to read, store and operate on byte data where the byte is specified based on upper/lower byte bits in the instruction. This architecture permits a new generation of processor having word widths of more than one byte to be backward compatible with software written for byte width processors.

### FIELD OF THE INVENTION

The present invention relates to systems and methods for addressing memory locations and, more particularly, to systems and methods for dynamically addressing a memory using variable word widths.

### BACKGROUND OF THE INVENTION

Processors, including microprocessors, digital signal processors and microcontrollers, generally operate on data in blocks called words. Each word has conventionally been defined as one byte (eight bits) or a multiple of a power of two bytes. Accordingly, processor word widths have been, for example, 8, 16, 32 and 64 bits. Processors with wider word widths may perform more accurate calculations by using and retaining more significant digits during processing. Other things being equal, processors with wider word widths tend to be more complex but also perform operations more quickly and in parallel by comparison to processors with various word widths. Successive generations of processors tend to be designed using wider word widths in order to capitalize on the above advantages.

One problem with creating a new generation of processors within a line of processors is ensuring backward compatibility. When a new processor is created with a wider word width than a previous generation, the new processor may no longer be compatible with software written for the earlier generation of processor. This may occur because software written for the earlier generation processor may presume a certain word width and include mathematical operations and instruction sequences based on that word width. The same mathematical operations and instructions may not, however, be valid on any machine having a different word width.

For this reason, there is a need to provide a new generation of processors that has a wider word width but that may process instructions in the same manner as a shorter word-width processor to ensure compatibility. This ensures backward compatibility with earlier generation processors and still capitalizes on improvements accompanying wider word width processors.

Conventionally, processors have provided logic to align word data between a processor and external data sources that may utilize, for example, conflicting big endian or little endian data conventions. Generally these processors include logic for receiving an aligning external data and swapping the order of bits within a received word of the same width. Processors have also provided a select few registers that may be larger than the native word width of a processor to permit, for example, double precision operations to be performed on that data. These conventional techniques do not, however, address backward compatibility or how to handle instruction processing in and/or storage of data in a memory dynamically changeable word width formats.

Accordingly, there is a need for a new processor architecture that allows a processor to process the same instruction in more than one word width depending on the mode of an instruction to ensure backward compatibility. There is a further need for the processor utilize memory of the processor in multiple word width modes and in particular in a native word width mode and a smaller word width mode such as a byte width mode.

### SUMMARY OF THE INVENTION

According to the present invention, a processor is provided that has a native word width of multiples of a byte width. The processor may, nonetheless process, store and retrieve data in word or byte widths depending on the mode of an instruction directing the processing. Instructions may assume either a word or a byte mode. In the word mode, the instruction causes the processor to read, store and operate on word width data. In the byte mode, the instruction causes the processor to read, store and operate on byte data where the byte is specified based on upper/lower byte bits in the instruction. This architecture permits a new generation of processor having word widths of more than one byte to be backward compatible with software written for byte width processors. The architecture also is implemented in such a way that the same instruction may be processed on byte or word data depending on the mode (or generation) of the instruction.

A method of processing byte and word instructions dynamically in the same processor, comprising includes fetching and decoding an instruction having a byte/word bit and an upper/lower byte bit. The method further includes generating an address for a memory based on the instruction. When the byte/word bit is set to a word value, method establishes a write path between upper and lower bytes of a bus and upper and lower bytes of a memory location at the generated address. When the byte/word bit is set to a byte value, the method establishes a write path between the lower bytes of a bus and the upper or lower bytes of a memory location at the generated address based on the upper/lower byte bit. The method may further include flagging an addressing error when the byte/word bit is set to a word value and the upper/lower byte bit is set to upper.

### BRIEF DESCRIPTION OF THE FIGURES

The above described features and advantages of the present invention will be more fully appreciated with reference to the detailed description and appended figures in which:

FIG. 1 depicts a functional block diagram of an embodiment of a processor chip within which embodiments of the present invention may find application.

FIG. 2 depicts a functional block diagram of a data busing scheme for use in a processor, which has a microcontroller and a digital signal processing engine, within which embodiments of the present invention may find application.

FIG. 3 depicts a functional block diagram of the interaction between an instruction decoder, an ALU, an address generation unit and memory for addressing the memory using dynamically variable word widths.

FIG. 4A depicts a functional block diagram of the interaction between the address generation unit and the data memory for addressing and writing to the memory in dynamically variable word widths.

FIG. 4B depicts a functional block diagram of the interaction between the address generation unit and the data memory for addressing and reading from the memory in dynamically variable word widths.

FIG. 5 depicts a method of addressing a memory based on dynamically variable word widths.

### DETAILED DESCRIPTION

According to the present invention, a processor is provided that has a native word width of multiples of a byte width. The processor may, nonetheless process, store and retrieve data in word or byte widths depending on the mode of an instruction directing the processing. Instructions may specify either a word or a byte mode. In the word mode, the instruction causes the processor to read, store and operate on word width data. In the byte mode, the instruction causes the processor to read, store and operate on byte data where the byte is specified based on upper/lower byte bits in the instruction. This architecture permits a new generation of processor having word widths of more than one byte to be backward compatible with software written for byte width processors. The architecture also is implemented in such a way that the same instruction may be processed on byte or word data depending on the mode (or generation) of the instruction.

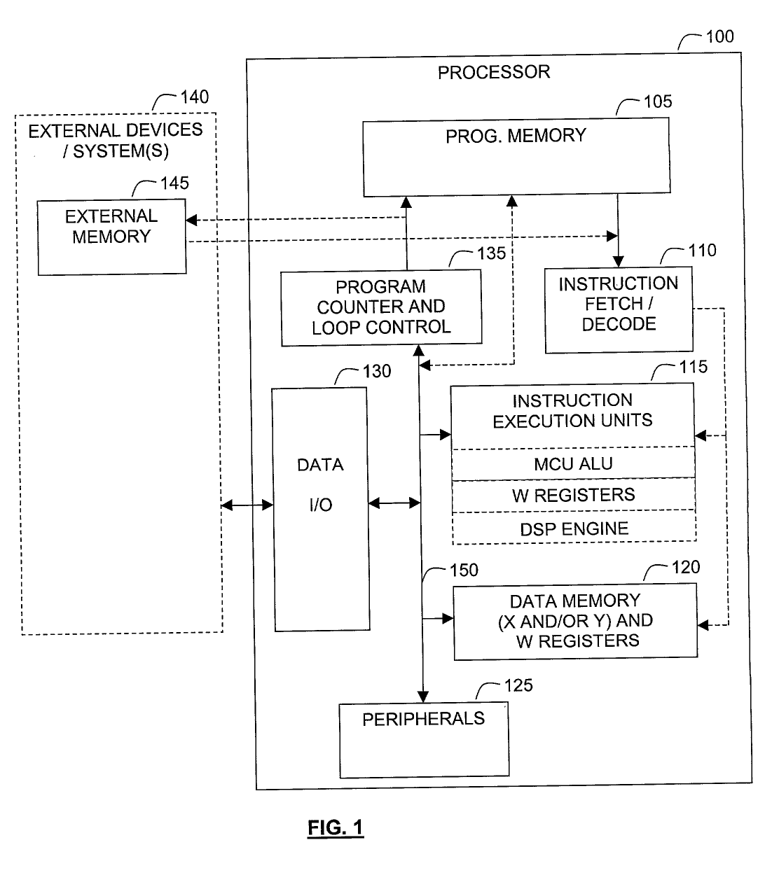

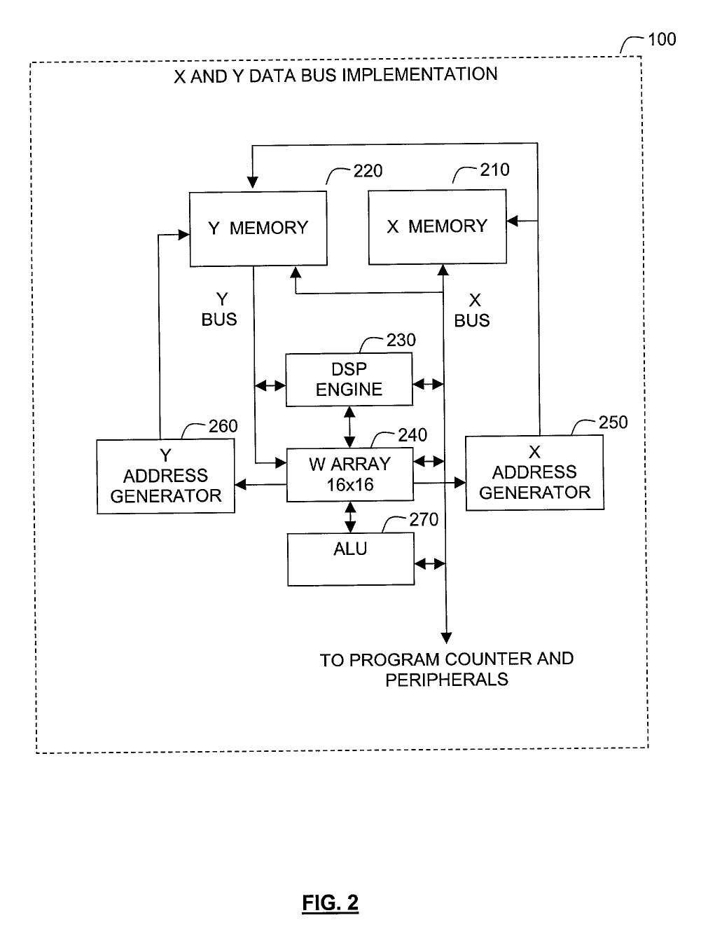

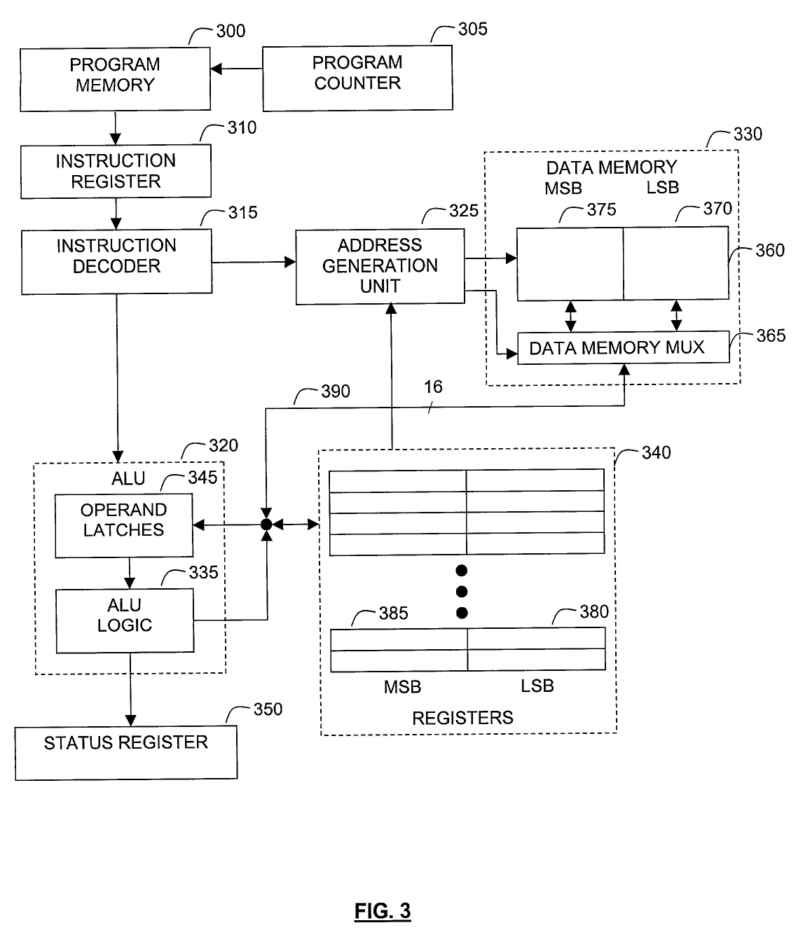

In order to describe embodiments of processing instructions in word and/or byte modes, an overview of pertinent processor elements is first presented with reference to FIGS. 1 and 2. The systems and methods for implementing word and/or byte mode processing are then described more particularly with reference to FIGS. 3-5.

Overview of Processor Elements

FIG. 1 depicts a functional block diagram of an embodiment of a processor chip within which the present invention may find application. Referring to FIG. 1, a processor 100 is coupled to external devices/systems 140. The processor 100 may be any type of processor including, for example, a digital signal processor (DSP), a microprocessor, a microcontroller or combinations thereof. The external devices 140 may be any type of systems or devices including input/output devices such as keyboards, displays, speakers, microphones, memory, or other systems which may or may not include processors. Moreover, the processor 100 and the external devices 140 may together comprise a stand alone system.

The processor 100 includes a program memory 105, an instruction fetch/decode unit 110, instruction execution units 115, data memory and registers 120, peripherals 125, data I/O 130, and a program counter and loop control unit 135. The bus 150, which may include one or more common buses, communicates data between the units as shown.

The program memory 105 stores software embodied in program instructions for execution by the processor 100. The program memory 105 may comprise any type of nonvolatile memory such as a read only memory (ROM), a programmable read only memory (PROM), an electrically programmable or an electrically programmable and erasable read only memory (EPROM or EEPROM) or flash memory. In addition, the program memory 105 may be supplemented with external nonvolatile memory 145 as shown to increase the complexity of software available to the processor 100. Alternatively, the program memory may be volatile memory which receives program instructions from, for example, an external non-volatile memory 145. When the program memory 105 is nonvolatile memory, the program memory may be programmed at the time of manufacturing the processor 100 or prior to or during implementation of the processor 100 within a system. In the latter scenario, the processor 100 may be programmed through a process called in-line serial programming.

The instruction fetch/decode unit 110 is coupled to the program memory 105, the instruction execution units 115 and the data memory 120. Coupled to the program memory 105 and the bus 150 is the program counter and loop control unit 135. The instruction fetch/decode unit 110 fetches the instructions from the program memory 105 specified by the address value contained in the program counter 135. The instruction fetch/decode unit 110 then decodes the fetched instructions and sends the decoded instructions to the appropriate execution unit 115. The instruction fetch/decode unit 110 may also send operand information including addresses of data to the data memory 120 and to functional elements that access the registers.

The program counter and loop control unit 135 includes a program counter register (not shown) which stores an address of the next instruction to be fetched. During normal instruction processing, the program counter register may be incremented to cause sequential instructions to be fetched. Alternatively, the program counter value may be altered by loading a new value into it via the bus 150. The new value may be derived based on decoding and executing a flow control instruction such as, for example, a branch instruction. In addition, the loop control portion of the program counter and loop control unit 135 may be used to provide repeat instruction processing and repeat loop control as further described below.

The instruction execution units 115 receive the decoded instructions from the instruction fetch/decode unit 110 and thereafter execute the decoded instructions. As part of this process, the execution units may retrieve one or two operands via the bus 150 and store the result into a register or memory location within the data memory 120. The execution units may include an arithmetic logic unit (ALU) such as those typically found in a microcontroller. The execution units may also include a digital signal processing engine, a floating point processor, an integer processor or any other convenient execution unit. A preferred embodiment of the execution units and their interaction with the bus 150, which may include one or more buses, is presented in more detail below with reference to FIG. 2.

The data memory and registers 120 are volatile memory and are used to store data used and generated by the execution units. The data memory 120 and program memory 105 are preferably separate memories for storing data and program instructions respectively. This format is a known generally as a Harvard architecture. It is noted, however, that according to the present invention, the architecture may be a Von-Neuman architecture or a modified Harvard architecture which permits the use of some program space for data space. A dotted line is shown, for example, connecting the program memory 105 to the bus 150. This path may include logic for aligning data reads from program space such as, for example, during table reads from program space to data memory 120.

Referring again to FIG. 1, a plurality of peripherals 125 on the processor may be coupled to the bus 150. The peripherals may include, for example, analog to digital converters, timers, bus interfaces and protocols such as, for example, the controller area network (CAN) protocol or the Universal Serial Bus (USB) protocol and other peripherals. The peripherals exchange data over the bus 150 with the other units.

The data I/O unit 130 may include transceivers and other logic for interfacing with the external devices/systems 140. The data I/O unit 130 may further include functionality to permit in circuit serial programming of the Program memory through the data I/O unit 130.

FIG. 2 depicts a functional block diagram of a data busing scheme for use in a processor 100, such as that shown in FIG. 1, which has an integrated microcontroller arithmetic logic unit (ALU) 270 and a digital signal processing (DSP) engine 230. This configuration may be used to integrate DSP functionality to an existing microcontroller core. Referring to FIG. 2, the data memory 120 of FIG. 1 is implemented as two separate memories: an X-memory 210 and a Y-memory 220, each being respectively addressable by an X-address generator 250 and a Y-address generator 260. The X-address generator may also permit addressing the Y-memory space thus making the data space appear like a single contiguous memory space when addressed from the X address generator. The bus 150 may be implemented as two buses, one for each of the X and Y memory, to permit simultaneous fetching of data from the X and Y memories.

The W registers 240 are general purpose address and/or data registers. The DSP engine 230 is coupled to both the X and Y memory buses and to the W registers 240. The DSP engine 230 may simultaneously fetch data from each the X and Y memory, execute instructions which operate on the simultaneously fetched data and write the result to an accumulator (not shown) and write a prior result to X or Y memory or to the W registers 240 within a single processor cycle.

In one embodiment, the ALU 270 may be coupled only to the X memory bus and may only fetch data from the X bus. However, the X and Y memories 210 and 220 maybe addressed as a single memory space by the X address generator in order to make the data memory segregation transparent to the ALU 270. The memory locations within the X and Y memories may be addressed by values stored in the W registers 240.

Any processor clocking scheme may be implemented for fetching and executing instructions. A specific example follows, however, to illustrate an embodiment of the present invention. Each instruction cycle is comprised of four Q clock cycles Q1-Q4. The four phase Q cycles provide timing signals to coordinate the decode, read, process data and write data portions of each instruction cycle.

According to one embodiment of the processor 100, the processor 100 concurrently performs two operations—it fetches the next instruction and executes the present instruction.

Accordingly, the two processes occur simultaneously. The following sequence of events may comprise, for example, the fetch instruction cycle:

| | |
|---|---|
| Q1: | Fetch Instruction |
| Q2: | Fetch Instruction |
| Q3: | Fetch Instruction |
| Q4: | Latch Instruction into prefetch register, Increment PC |

The following sequence of events may comprise, for example, the execute instruction cycle for a single operand instruction:

| | |
|---|---|
| Q1: | latch instruction into IR, decode and determine addresses of |
| | operand data |
| Q2: | fetch operand |
| Q3: | execute function specified by instruction and calculate destination |
| | address for data |
| Q4: | write result to destination |

The following sequence of events may comprise, for example, the execute instruction cycle for a dual operand instruction using a data pre-fetch mechanism. These instructions pre-fetch the dual operands simultaneously from the X and Y data memories and store them into registers specified in the instruction. They simultaneously allow instruction execution on the operands fetched during the previous cycle.

| | |
|---|---|
| Q1: | latch instruction into IR, decode and determine addresses of |
| | operand data |
| Q2: | pre-fetch operands into specified registers, execute operation in |
| | instruction |
| Q3: | execute operation in instruction, calculate destination address for |
| | data |
| Q4: | complete execution, write result to destination |

Byte/Word Addressing and Processing

FIG. 3 depicts a functional block diagram of a processor for processing bit operations according to the present invention. Referring to FIG. 3, the processor includes a program memory 300 for storing instructions including instructions that operate in both word and byte modes. The processor also includes a program counter 305 which stores a pointer to the next program instruction that is to be fetched. The processor further includes an instruction register 310 for storing an instruction for execution that has been fetched from the program memory 300. The processor may further include pre-fetch registers or an instruction pipeline (not shown) that may be used for fetching and storing a series of upcoming instructions for decoding and execution. The processor also includes an instruction decoder 315, an arithmetic logic unit (ALU) 320, registers 340, a status register 350 and a data memory 330. The data memory 330 is addressed by an address generation unit 325.

The instruction decoder 315 decodes instructions that are stored in the instruction register 310. Based on the bits in the instruction, the instruction decoder 315 selectively activates logic within the ALU 320 for fetching operands, performing the operation specified by the instruction on the operands and returning the result to the appropriate memory location.

The ALU 320 includes operand latches 345 that receive operands from the registers 340 and/or a data memory 330 depending on the addressing mode used in the instruction. For example in one addressing mode, the source and/or destination operand data may be stored in the registers 340. In another addressing mode, the source and/or destination operand data may be stored in the data memory 355.

The ALU 320 includes ALU logic 335, each of which receives inputs from the operand latches 345 and produces outputs to the bus 390 and the status register 350. The ALU logic 350 executes arithmetic and logic operations according to instructions decoded by the instruction decoder on operands fetched from the registers 340 and/or from the data memory 330. In general, the ALU 320 processes data in byte or word widths.

The instruction decoder 315 decodes particular instructions and sends control signals to the ALU 320, the address generation unit 325 and directs the fetching of the correct operands specified in the instruction. The instruction decoder 315 also, based on the instruction, sends control signals directing the activation of the correct portion of the ALU logic 335 to carry out the operation specified by the instruction on the correct operands, directing the result to be written to the correct destination and directing the status register to store pertinent data when present, such as a status flag indicating a zero result.

The data memory 330 is coupled to the address generation unit and the bus 390. The address unit provides addresses to the data memory for retrieving operands and other data that are stored in the memory during processor read cycles and for storing operands and other data into the data memory during processor write cycles. Data read from the memory and stored into the memory is communicated to other units of the processor via the bus 390, which is coupled to, among other units, the data memory 330, the registers 340 and the ALU 320.

The data memory may be any convenient size based on the processing power of the processor and the target applications. As an illustrative example, the data memory 330 may be configured as a 64 K-bit memory array 360 having a 4 K bit×16 bit arrangement. The 16 bit wide memory accordingly has a native word width of two bytes, lower byte 370 and upper byte 375.

The data memory also includes a data memory multiplexer 365 which directs data from the bus 390 into the appropriate upper byte 375 and/or lower byte 370 during a write cycle depending on whether the instruction specifies a byte or word mode of operation. The data memory multiplexer 365 directs data to the bus 390 from the appropriate upper byte 375 and/or lower byte 370 during a read cycle depending on whether the instruction specifies a byte or word mode of operation.

In order to implement byte or word mode of operation, one or more instructions within the instruction set of the processor may specify the byte or word mode of operation. This may be encoded within the instruction in the following manner with two bits:

word/byte bit: 0 for word, 1 for byte mode (or vice-versa)

upper/lower byte bit: 0 for lower byte and word operations, 1 for upper byte.

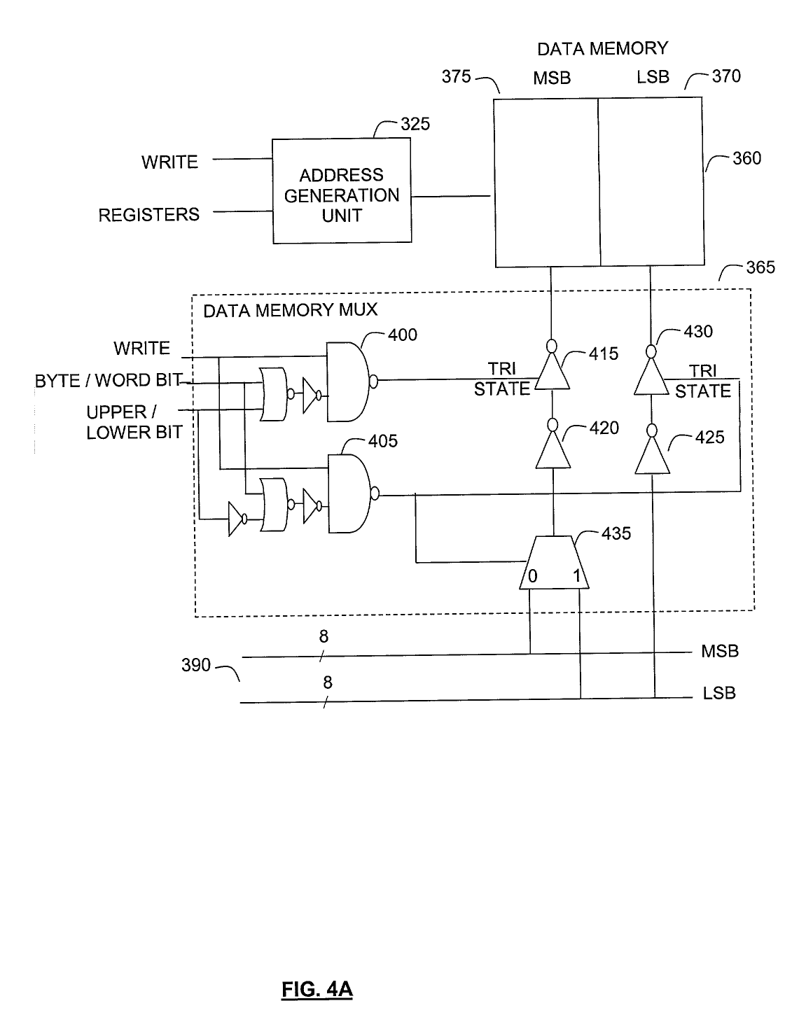

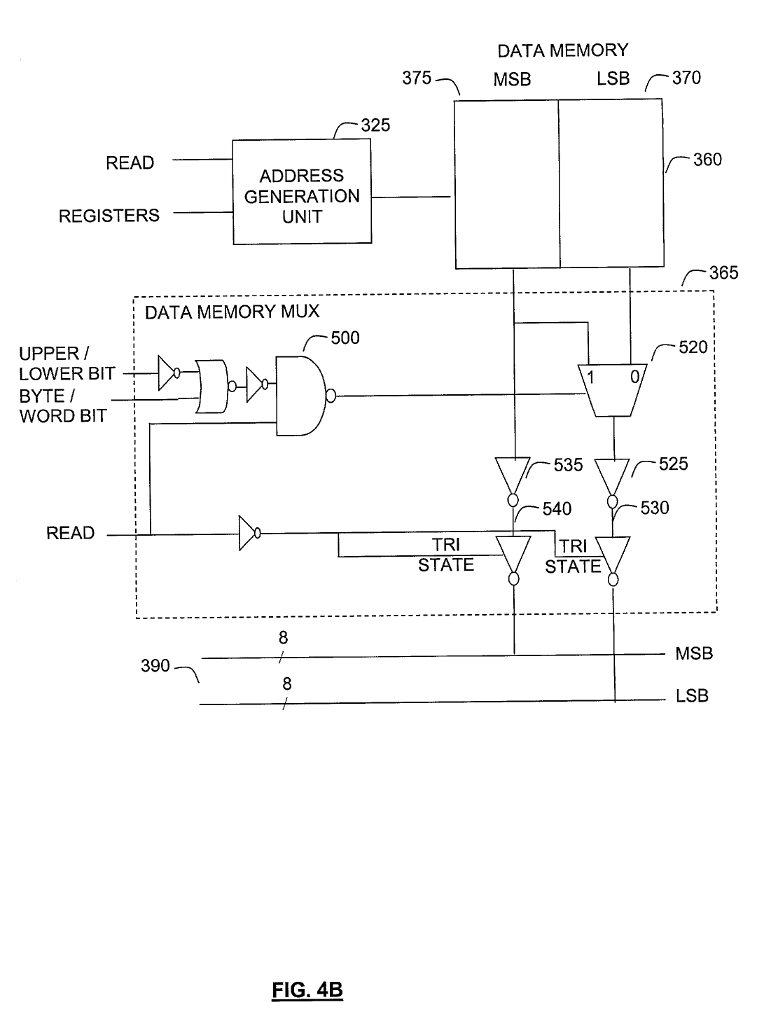

FIG. 4A depicts an interaction between the address generation unit 325, the data memory array 360 and the data memory multiplexer 365 during a write cycle. The interaction depicts an illustrative embodiment that may be used to direct the storage of individual bytes or words into the upper and lower bytes of the data memory array 360.

Referring to FIG. 4A, the address generation unit may receive a pointer from the registers 340 specifying an individual memory word location within the memory array 360. The address generation unit decodes the pointer to determine the individual memory word location. The address generation unit may also receive a write clock signal which gates the address decoding such that the individual memory word location is only activated (by raising a word line voltage for example) during memory write cycles.

The data memory multiplexer 365 receives the write clock signal and the byte/word bit value as well as the upper/lower byte bit value. The latter two values may be received directly from the instruction decoder 315 or from the instruction decoder 315 by way of the address generation unit 325. The data memory multiplexer may be implemented in many different ways to steer data to and from the bus 390 and the appropriate upper and/or lower bytes of the memory array 360.

The status register stores flag values indicating various conditions within the processor and the ALU result. During a byte operation, the flags are derived based on the lower eight bits of the result generated by the ALU for an instruction, rather than the entire word result. This is because the upper 8 bits of the result for a byte operation may not contain meaningful data.

Referring to the embodiment depicted in FIG. 4A, the multiplexer 365 includes two logic trees 400 and 405 for generating control signals to direct the writing of bytes from the bus into the appropriate byte locations in the memory array 360. The logic trees 400 and 405 generate the same signal during a write cycle when the byte/word bit is set high indicating a word operation. The signal generated is low and is fed to the tri state buffers 415 and 430 thus activating the tri state buffers. With the tri state buffers 415 and 430 active, the value from the LSB of the bus 390 is written into the LSB 370 of the memory array 360 through gate 425 and the tri-state buffer. The value from the MSB of the bus 390 is selected by the multiplexer 435 based on the zero value from the logic tree 405 fed to its control input. The MSB value is in turn written into the MSB 375 of the memory array 360 through the gate 420 and the tri-state buffer 415.

The logic trees 400 and 405 generate opposing signals when the byte/word bit is set low indicating a byte operation. When the upper/lower bit is set to a zero, the logic tree 400 generates a high output signal which disables the tri-state buffer 415. Thus, data from the bus is not written into the MSB 375 of the memory. By contrast, the logic tree 405 generates a low output signal thus activating the tri-state buffer 430 causing data to be written from the LSB of the bus 390 into the LSB of the memory array 360.

When the word/byte bit is set to a zero and the upper/lower bit is set to a one, the logic tree 405 generates a high output signal which disables the tri-state buffer 430 and sets the control input of the multiplexer to select the LSB of the bus 390. Thus, data from the bus is not written into the LSB 375 of the memory. By contrast, the logic tree 405 generates a low output signal thus activating the tri-state buffer 415. The values from the trees 400 and 405 cause the multiplexer 435 to select the LSB from the bus 390 and write the data into the LSB 375 of the memory array 360. This arrangement provides for proper operation and alignment of byte and word writes to the memory array 360.

FIG. 4B depicts an interaction between the address generation unit 325, the data memory array 360 and the data memory multiplexer 365 during a read cycle. The illustrative embodiment may be used to direct the retrieval of individual bytes or words into the upper and lower bytes of the data memory array 360.

Referring to FIG. 4B, the address generation unit may receive a pointer from the registers 340 specifying an individual memory word location within the memory array 360. The address generation unit decodes the pointer to determine the individual memory word location. The address generation unit may also receive a read clock signal which gates the address decoding such that the individual memory word location is only activated (by raising a word line voltage for example) during memory read cycles.

The data memory multiplexer 365 receives the read clock signal and the byte/word bit value as well as the upper/lower byte bit value. The latter two values may be received directly from the instruction decoder 315 or from the instruction decoder 315 by way of the address generation unit 325. The multiplexer 365 includes a logic trees 500 for generating a control signal to direct the reading of bytes from the memory array 360 into the appropriate byte positions on the bus 390. The logic tree 500 generates a signal that is set low during a write cycle when the byte/word bit is set high indicating a word operation. An inverted version of the read signal is generated during a read cycle and its low value is fed to the tri state buffers 530 and 540 thus activating them. With the tri state buffers 530 and 540 active, the value from the MSB of the memory address activated by the address generation unit 325 is read onto the MSB of the bus 390 through gate 535 and the tri-state buffer 540. The value from the LSB 370 of the memory array 360 is selected by the multiplexer 520 based on the zero value from the logic tree 500 fed to its control input. The selected LSB value is in turn written onto the LSB of the bus 390 through the gate 525 and the tri-state buffer 530.

When the byte/word bit is set low indicating a byte operation, the signal generated by the logic tree 500 is set equal to the value of the upper/lower byte bit. Accordingly, when the upper/lower bit is set to a zero, the logic tree 500 generates a low output signal which sets the control input of the multiplexer to select the LSB 370 of the memory array 360. Thus, data from the LSB 370 is selected and read onto the LSB of the bus 390. By contrast, the logic tree 500 generates a high output signal when the upper/lower byte bit is high causing the multiplexer 520 to select the MSB 375 from the memory array 360 and write the data into the LSB of the bus 390. This arrangement provides for proper operation and alignment of byte and word reads from the memory array 360.

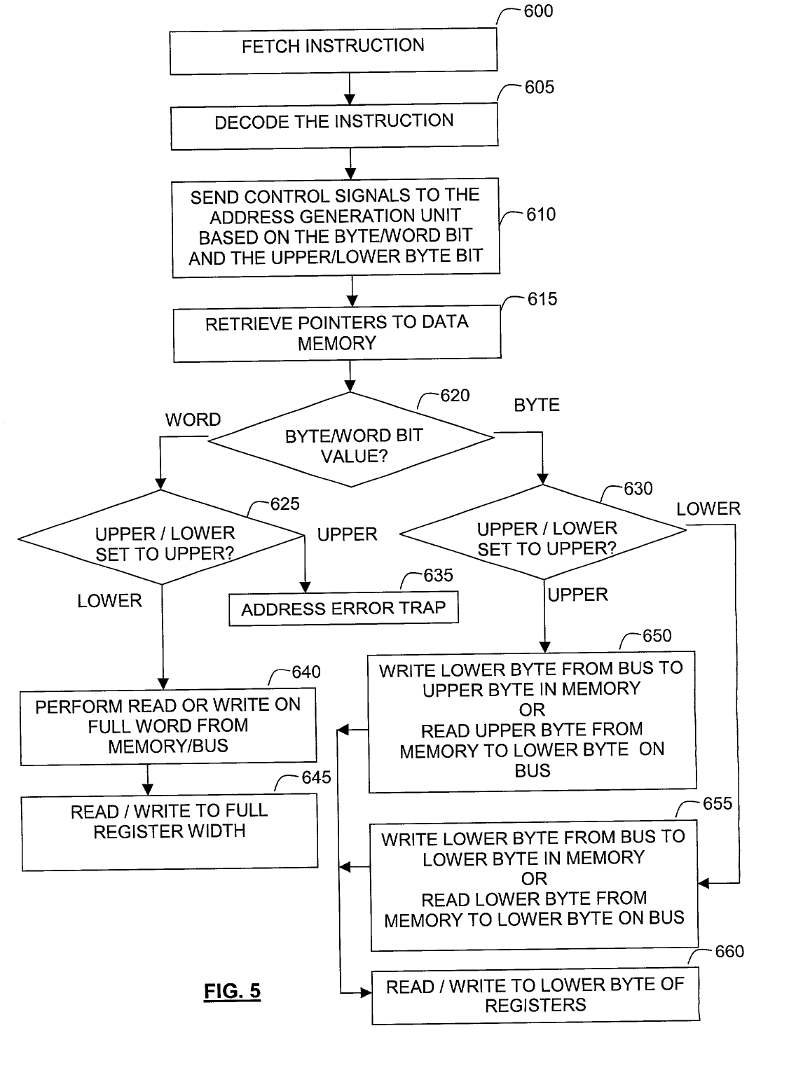

FIG. 5 depicts a method of addressing a memory based on dynamically variable word widths. Referring to FIG. 5, in step 600, the processor fetches an instruction. Then in step 605, the instruction decoder decodes the instruction. In step 610, the instruction decoder sends control signals to the address generation unit based on the byte/word bit and the upper/lower byte bits within the instruction. These control signals determine whether the memory will be accessed and the instruction will be processed as a word or a particular byte. In step 615, the address generation unit retrieves pointers to data memory. In general, the pointers are retrieved from a registers specified in the instruction under control of the instruction decoder.

In step 620, logic determines whether the byte/word bit value specifies a word or a byte. When the byte/word bit value specifies a word, then step 625 begins. When the byte/word bit value specifies a byte, then step 630 begins. In step 625, logic checks to determine whether the upper/lower byte bit is set to upper. If the upper/lower byte bit is set to upper, then step 635 begins and an address error trap flag is set. Subsequently, the processor may cause a corresponding address trap interrupt service routine to be executed. Alternatively, if the upper/lower byte bit is set to lower, then step 640 begins. Step 625 may be implemented by checking for a condition where the byte/word bit is set to word and the upper/lower byte bit is set to upper.

In step 640, the processor performs a read or write on a full word from/to the memory and/or bus. In step 645, any values read out of the memory in step 640 are written to a full register width. Accordingly, words are written into and out of the memory.

Step 630 begins if the byte/word bit value is set to byte. In step 630, the processor checks to see if the upper/lower byte bit is set to upper or lower. When it is set to upper, step 650 begins and the processor either writes the lower byte from the bus to the upper byte in memory or reads the upper byte from memory onto the lower byte on the bus.

If in step 630 the processor determines that the upper/lower byte bit is set to lower, then step 655 begins. In step 655, the processor either writes the lower byte from the bus to the lower byte in memory or reads the lower byte from memory onto the lower byte on the bus.

After steps 650 and 655, step 660 begins and the processor reads/writes to the lower byte of the registers. In this manner, for byte operations, reads and writes are conducted in a manner which preserves the alignment of data within the memory, on the bus and within the registers.

While specific embodiments of the present invention have been illustrated and described, it will be understood by those having ordinary skill in the art that changes may be made to those embodiments without departing from the spirit and scope of the invention.

What is claimed is:

1. A method of processing byte and word instruction operands dynamically in the same processor, comprising:
fetching and decoding an instruction having a byte/word bit and an upper/lower byte bit;
generating an address for a memory based on the instruction;
establishing a write path between upper and lower bytes of a bus and upper and lower bytes of a memory location at the generated address when the byte/word bit is set to a word value and establishing a write path between the lower bytes of a bus and the upper or lower bytes of a memory location at the generated address based on the upper/lower byte bit when the byte/word bit is set to a byte value.

2. The method according to claim 1, wherein the address is generated based on a pointer value stored in a register.

3. The method according to claim 1, further comprising flagging an addressing error when the byte/word bit is set to a word value and the upper/lower byte bit is set to upper.

4. A method of processing byte and word instruction operands dynamically in the same processor, comprising:
fetching and decoding an instruction having a byte/word bit and an upper/lower byte bit;
generating an address for a memory based on the instruction;
establishing a read path between upper and lower bytes of a bus and upper and lower bytes of a memory location at the generated address when the byte/word bit is set to a word value and establishing a read path between the lower bytes of a bus and the upper or lower bytes of a memory location at the generated address based on the upper/lower byte bit when the byte/word bit is set to a byte value.

5. The method according to claim 4, wherein the address is generated based on a pointer value stored in a register.

6. The method according to claim 4, further comprising flagging an addressing error when the byte/word bit is set to a word value and the upper/lower byte bit is set to upper.
